(19) United States
(12) Patent Application Publication
(10) Pub. No.: US 2024/0219179 A1
(43) Pub. Date: Jul. 4, 2024

(54) Angular Velocity Sensor

(71) Applicant: SEIKO EPSON CORPORATION, Tokyo (JP)

(72) Inventor: Norifumi SHIMIZU, Matsumoto (JP)

(21) Appl. No.: 18/397,524

(22) Filed: Dec. 27, 2023

(30) Foreign Application Priority Data
Dec. 28, 2022 (JP) 2022-212426

(51) Int. Cl. G01C 19/5747; G01C 19/5769

(52) U.S. Cl. CPC G01C 19/5747; G01C 19/5769

(57) ABSTRACT

An angular velocity sensor includes a package, a support substrate that includes a substrate having an opening and that includes first to sixth leads extending into the opening, and an angular velocity detection element coupled to the first to sixth leads. When axes that pass through the center of gravity of the angular velocity detection element and are orthogonal to each other in a plan view are defined as a first axis and a second axis, the substrate includes a first adjustment portion that is located on one side of the first axis, that is coupled to the first to third leads, and that reduces a difference in length among the first to third leads as compared with a case where the opening has a rectangular shape, a second adjustment portion that is located on the other side of the first axis, that is coupled to the fourth to sixth leads, and that reduces a difference in length among the fourth to sixth leads as compared with a case where the opening has a rectangular shape, and a third adjustment portion that is disposed between the first adjustment portion and the second adjustment portion and that sets a length of the opening in a direction along the second axis to be larger than a length of the opening in a direction along the first axis.

The present application is based on, and claims priority from JP Application Serial Number 2022-212426, filed Dec. 28, 2022, the disclosure of which is hereby incorporated by reference herein in its entirety.

### BACKGROUND

### 1. Technical Field

The present disclosure relates to an angular velocity sensor.

### 2. Related Art

An angular velocity sensor disclosed in JP-A-2007-024741 includes a package, a gyro vibrator element and a support substrate that are provided in the package. The gyro vibrator element is supported by the package via the support substrate. The support substrate includes six leads whose tip end portions are coupled to the gyro vibrator element, and a base material that supports base portions of the leads. The six leads extend in a radial shape from a base portion of the gyro vibrator element and are in point symmetry relative to the center of gravity of the gyro vibrator element in plan view. Accordingly, lengths of the leads match with one another, and the gyro vibrator element is supported in a balanced manner.

However, in the angular velocity sensor disclosed in JP-A-2007-024741, it is assumed that an electrode bump that couples the gyro vibrator element and the leads is disposed on a virtual circumference centered on the center of gravity of the gyro vibrator element, and the leads extend from the electrode bump. Therefore, the degree of freedom in designing the leads is low, and the leads and a gyro element may resonate.

### SUMMARY

An angular velocity sensor according to the disclosure includes: a package;
a support substrate that is disposed in the package, that includes a substrate having an opening, and that includes a first lead, a second lead, a third lead, a fourth lead, a fifth lead, and a sixth lead supported by the substrate and extending into the opening in a plan view of the substrate; and
an angular velocity detection element that is disposed in a manner of overlapping the support substrate in the package, and is coupled to the first lead, the second lead, the third lead, the fourth lead, the fifth lead, and the sixth lead, in which
when axes that pass through the center of gravity of the angular velocity detection element and are orthogonal to each other in the plan view are defined as a first axis and a second axis, the substrate includes
a first adjustment portion that is located on one side of the first axis, that is coupled to the first lead, the second lead, and the third lead, and that reduces a difference in length among the first lead, the second lead, and the third lead as compared with a case where the opening has a rectangular shape,
a second adjustment portion that is located on the other side of the first axis, that is coupled to the fourth lead, the fifth lead, and the sixth lead, and that reduces a difference in length among the fourth lead, the fifth lead, and the sixth lead as compared with a case where the opening has a rectangular shape, and
a third adjustment portion that is disposed between the first adjustment portion and the second adjustment portion and sets a length of the opening in a direction along the second axis to be larger than a length of the opening in a direction along the first axis.

### BRIEF DESCRIPTION OF THE DRAWINGS

FIG. 1 is a cross-sectional view showing an angular velocity sensor according to a first embodiment.

FIG. 2 is a top view showing an angular velocity detection element.

FIG. 3 is a schematic view showing a drive vibration mode of the angular velocity detection element.

FIG. 4 is a schematic diagram showing a detection vibration mode of the angular velocity detection element.

FIG. 5 is a top view showing a support substrate.

FIG. 6 is a top view sowing the support substrate.

FIG. 7 is a top view showing the support substrate.

FIG. 8 is a cross-sectional view showing an angular velocity sensor according to a second embodiment.

FIG. 9 is a top view showing a support substrate according to a third embodiment.

FIG. 10 is a top view showing a support substrate according to a fourth embodiment.

### DESCRIPTION OF EMBODIMENTS

Hereinafter, an angular velocity sensor according to the disclosure will be described in detail based on embodiments shown in the accompanying drawings. For the convenience of description, three axes orthogonal to one another are shown as an X axis, a Y axis, and a Z axis. A direction along the X axis is also referred to as an “X-axis direction”, a direction along the Y axis is also referred to as a “Y-axis direction”, and a direction along the Z axis is also referred to as a “Z-axis direction”. The Z axis is along a vertical direction, an arrow side is referred to as “upper”, and an opposite side is referred to as “lower”.

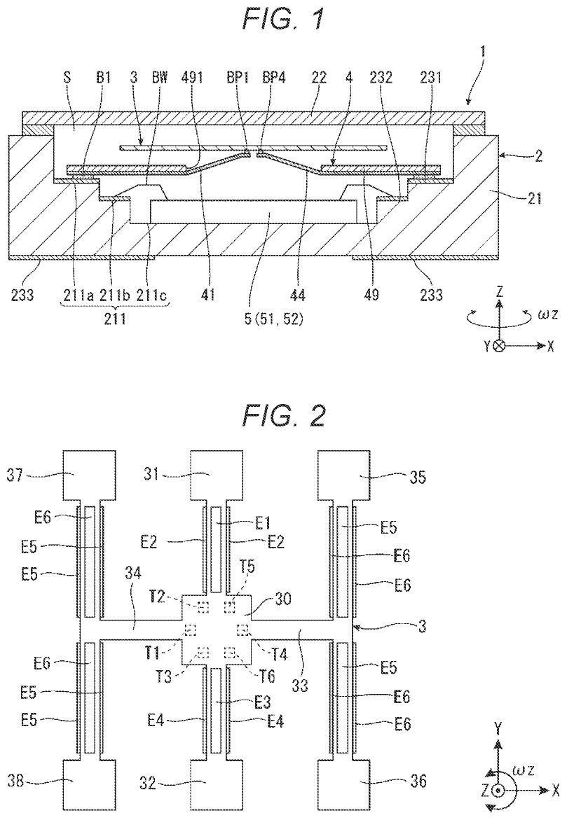

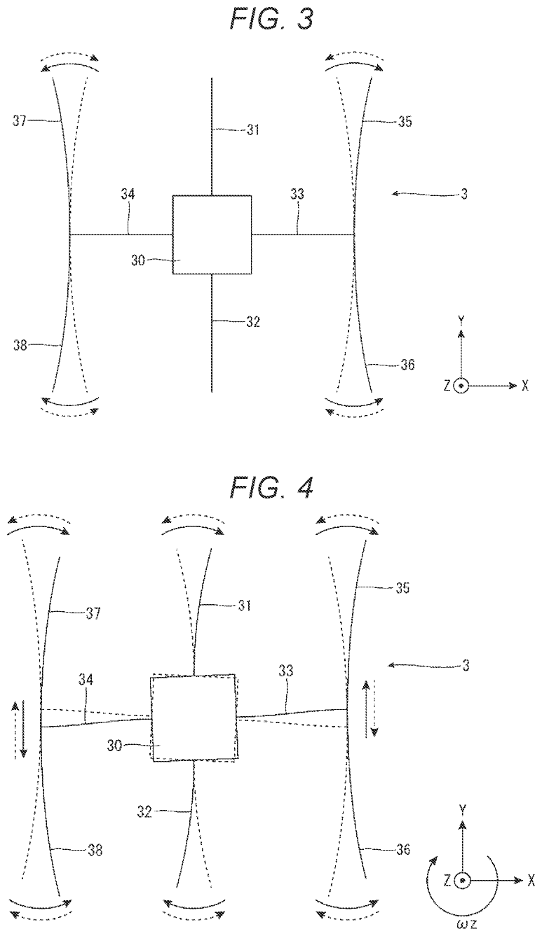

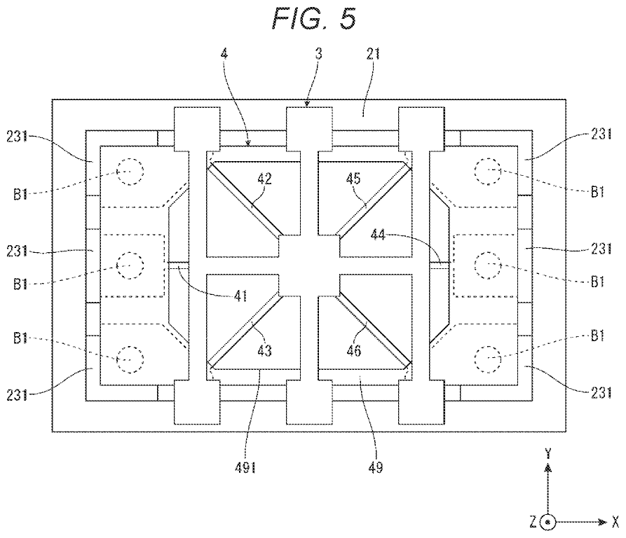

FIG. 1 is a cross-sectional view showing an angular velocity sensor according to a first embodiment. FIG. 2 is a top view showing an angular velocity detection element. FIG. 3 is a schematic diagram showing a drive vibration mode of the angular velocity detection element. FIG. 4 is a schematic diagram showing a detection vibration mode of the angular velocity detection element. FIGS. 5 to 7 are top views showing a support substrate.

An angular velocity sensor 1 shown in FIG. 1 is a sensor that detects an angular velocity ωz around the Z axis, and includes an angular velocity detection element 3 to which the angular velocity ωz is applied, a support substrate 4, a circuit element 5, and a package 2 that houses the angular velocity detection element 3, the support substrate 4, and the circuit element 5.

### Package

As shown in FIG. 1, the package 2 includes a cavity-shaped base 21 having a recessed portion 211 opened in an upper surface of the base 21, and a plate-shaped lid 22 that is bonded to the upper surface of the base 21 and closes an opening of the recessed portion 211. The package 2 has an internal space S, and the angular velocity detection element 3, the support substrate 4, and the circuit element 5 are accommodated in the internal space S in a manner of overlapping one another in the Z-axis direction. The internal space S is hermetically sealed, is in a depressurized state, and is preferably in a state closer to vacuum. Accordingly, a viscous resistance is reduced, and the angular velocity detection element 3 can be efficiently driven.

A constituent material of the base 21 is not particularly limited, and for example, various ceramics such as aluminum oxide can be used. A constituent material of the lid 22 is not particularly limited, and the lid 22 may be a member having a linear expansion coefficient similar to that of the constituent material of the base 21. For example, when the constituent material of the base 21 is ceramics, the lid 22 is preferably made of an alloy such as Kovar. A method of bonding the base 21 and the lid 22 is not particularly limited, and for example, the base 21 and the lid 22 may be bonded via a metallization layer, or may be bonded via an adhesive.

The recessed portion 211 includes a first recessed portion 211a that is opened on the upper surface of the base 21, a second recessed portion 211b that is opened on a bottom surface of the first recessed portion 211a and has an opening area smaller than that of the first recessed portion 211a, and a third recessed portion 211c that is opened on a bottom surface of the second recessed portion 211b and has an opening area smaller than that of the second recessed portion 211b. The circuit element 5 is fixed to a bottom surface of the third recessed portion 211c, the support substrate 4 is fixed to the bottom surface of the first recessed portion 211a, and the angular velocity detection element 3 is fixed to the support substrate 4.

A plurality of internal terminals 231 are disposed on the bottom surface of the first recessed portion 211a, a plurality of internal terminals 232 are disposed on the bottom surface of the second recessed portion 211b, and a plurality of external terminals 233 are disposed on a bottom surface of the base 21. The plurality of internal terminals 232 include terminals electrically coupled to the internal terminals 231 via internal wires (not shown) provided in the base 21 and terminals electrically coupled to the external terminals 233 via the internal wires. The internal terminals 231 are electrically coupled to the support substrate 4 via conductive bonding members B1, and the internal terminals 232 are electrically coupled to the circuit element 5 via bonding wires BW. The number and arrangement of the internal terminals 231, the internal terminals 232, and the external terminals 233 are not particularly limited, and for example, the number and arrangement may be appropriately set according to the number of terminals of the angular velocity detection element 3 or the circuit element 5.

### Angular Velocity Detection Element

The angular velocity detection element 3 is a quartz crystal vibration element. As shown in FIG. 2, the angular velocity detection element 3 includes a base portion 30 located in a central portion, a pair of detection vibration arms 31 and 32 extending from the base portion 30 to both sides in the Y-axis direction, a pair of support arms 33 and 34 extending from the base portion 30 to both sides in the X-axis direction, a pair of drive vibration arms 35 and 36 extending from a tip end portion of the support arm 33 to both sides in the Y-axis direction, and a pair of drive vibration arms 37 and 38 extending from a tip end portion of the support arm 34 to both sides in the Y-axis direction. The angular velocity detection element 3 is supported by the support substrate 4 at the base portion 30.

The angular velocity detection element 3 includes a first detection signal electrode E1 disposed on both main surfaces of the detection vibration arm 31, a first detection ground electrode E2 disposed on both side surfaces of the detection vibration arm 31, a second detection signal electrode E3 disposed on both main surfaces of the detection vibration arm 32, a second detection ground electrode E4 disposed on both side surfaces of the detection vibration arm 32, drive signal electrodes E5 disposed on both main surfaces of each of the drive vibration arms 35 and 36 and both side surfaces of each of the drive vibration arms 37 and 38, and drive ground electrodes E6 disposed on both side surfaces of each of the drive vibration arms 35 and 36 and both main surfaces of each of the drive vibration arms 37 and 38.

Six terminals T1, T2, T3, T4, T5, and T6 are arranged on a lower surface of the base portion 30. The terminal T1 is electrically coupled to the first detection signal electrode E1, the terminal T2 is electrically coupled to the first detection ground electrode E2, the terminal T3 is electrically coupled to the second detection signal electrode E3, the terminal T4 is electrically coupled to the second detection ground electrode E4, the terminal T5 is electrically coupled to the drive signal electrodes E5, and the terminal T6 is electrically coupled to the drive ground electrodes E6.

The angular velocity detection element 3 as described above detects an angular velocity ωz as follows. When a drive signal is applied to between the drive signal electrode E5 and the drive ground electrode E6, as shown in FIG. 3, the drive vibration arms 35 and 36 and the drive vibration arms 37 and 38 perform flexural vibrations in opposite phases along an X-Y plane (hereinafter, this state is also referred to as a “drive vibration mode”). In this state, vibrations of the drive vibration arms 35, 36, 37, and 38 are balanced, and the detection vibration arms 31 and 32 do not vibrate substantially. When the angular velocity ωz is applied to the angular velocity detection element 3 in a state in which the angular velocity detection element 3 is driven in the drive vibration mode, as shown in FIG. 4, Coriolis force acts on the drive vibration arms 35, 36, 37, and 38 to excite flexural vibrations in the Y-axis direction, and in response to such flexural vibrations, the detection vibration arms 31 and 32 perform flexural vibrations in the X-axis direction (hereinafter, this state is also referred to as a “detection vibration mode”).

Electric charges generated in the detection vibration arm 31 by such a detection vibration mode are taken out as a first output signal from the first detection signal electrode E1, electric charges generated in the detection vibration arm 32 are taken out as a second output signal from the second detection signal electrode E3, and the angular velocity ωz is obtained based on the first and second output signals.

### Support Substrate 4

As shown in FIG. 1, the support substrate 4 is fixed to the bottom surface of the first recessed portion 211a by the bonding member B1. The support substrate 4 is located below the angular velocity detection element 3 and supports the angular velocity detection element 3 in a manner of lifting the angular velocity detection element 3 from a lower side. The support substrate 4 is a substrate for tape automated bonding (TAB) mounting. As shown in FIG. 5, the support substrate 4 includes a plate-shaped substrate 49 having an opening 491, and a first lead 41, a second lead 42, a third lead 43, a fourth lead 44, a fifth lead 45, and a sixth lead 46 that are supported by the substrate 49. Hereinafter, the first, second, third, fourth, fifth, and sixth leads 41, 42, 43, 44, 45, and 46 are also simply referred to as leads 41, 42, 43, 44, 45, and 46. The substrate 49 is made of, for example, a flexible resin such as polyimide, and the leads 41, 42, 43, 44, 45, and 46 are made of, for example, copper foil.

The leads 41, 42, 43, 44, 45, and 46 are bonded to a lower surface of the substrate 49 by adhesives (not shown). The leads 41, 42, 43, 44, 45, and 46 are electrically coupled to the corresponding internal terminals 231 via the bonding members B1. Since the leads 41, 42, 43, 44, 45, and 46 are supported by the lower surface of the substrate 49 in this manner, the leads 41, 42, 43, 44, 45, and 46 can be made to face the internal terminals 231, and thus electrical coupling can be easily performed by the bonding members B1.

In a plan view from the Z-axis direction, tip end portions of the leads 41, 42, 43, 44, 45, and 46 extend into the opening 491. Hereinafter, when the leads 41, 42, 43, 44, 45, and 46 are simply referred to, the leads 41, 42, 43, 44, 45, and 46 refers to portions of the leads 41, 42, 43, 44, 45, and 46 extending into the openings 491.

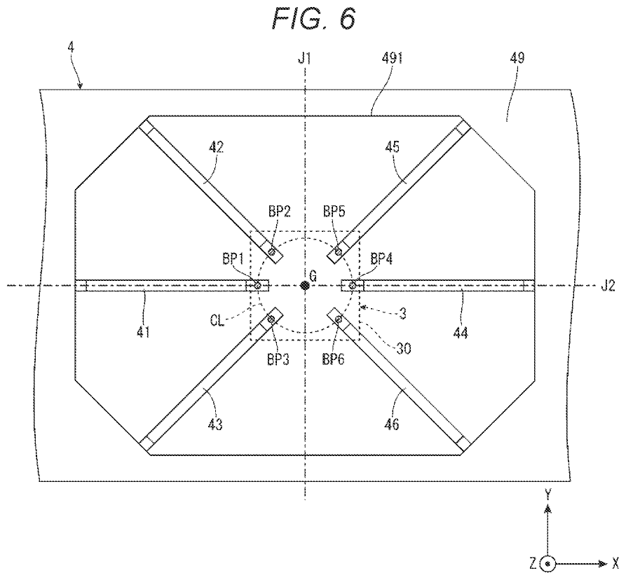

Although only the leads 41 and 44 are shown in FIG. 1, the leads 41, 42, 43, 44, 45, and 46 are bent and inclined in the middle, and tip end portions of the leads 41, 42, 43, 44, 45, and 46 are positioned above the substrate 49 through the opening 491. As shown in FIG. 6, the base portion 30 of the angular velocity detection element 3 is fixed to the tip end portions of the leads 41, 42, 43, 44, 45, and 46 via electrode bumps BP1, BP2, BP3, BP4, BP5, and BP6. Although not shown, the electrode bump BP1 electrically couples the terminal T1 and the lead 41, the electrode bump BP2 electrically couples the terminal T2 and the lead 42, the electrode bump BP3 electrically couples the terminal T3 and the lead 43, the electrode bump BP4 electrically couples the terminal T4 and the lead 44, the electrode bump BP5 electrically couples the terminal T5 and the fifth lead 45, and the electrode bump BP6 electrically couples the terminal T6 and the sixth lead 46. As shown in FIG. 6, the electrode bumps BP1 to BP6 are arranged along a virtual circle CL centered on the center of gravity G of the angular velocity detection element 3 in a plan view from the Z-axis direction.

The leads 41, 42, 43, 44, 45, and 46 are arranged in a radial shape relative to the center of gravity G in a plan view from the Z-axis direction. Specifically, the lead 41 extends along a virtual straight line passing through the center of gravity G and the center of the electrode bump BP1, the lead 42 extends along a virtual straight line passing through the center of gravity G and the center of the electrode bump BP2, the lead 43 extends along a virtual straight line passing through the center of gravity G and the center of the electrode bump BP3, the lead 44 extends along a virtual straight line passing through the center of gravity G and the center of the electrode bump BP4, the lead 45 extends along a virtual straight line passing through the center of gravity G and the center of the electrode bump BP5, and the lead 46 extends along a virtual straight line passing through the center of gravity G and the center of the electrode bump BP6. Therefore, the leads 41 and 44 are arranged in point symmetry relative to the center of gravity G, the leads 42 and 46 are arranged in point symmetry relative to the center of gravity G, and the leads 43 and 45 are arranged in point symmetry relative to the center of gravity G.

In such a configuration, when an axis passing through the center of gravity G and extending in the Y-axis direction is defined as a first axis J1, and an axis passing through the center of gravity G and extending in the X-axis direction is defined as a second axis J2 in a plan view from the Z-axis direction, the leads 41, 42, and 43 extend from a negative side in the X-axis direction relative to the first axis J1 toward the base portion 30, and the leads 44, 45, and 46 extend from a positive side in the X-axis direction relative to the first axis J1 toward the base portion 30. Therefore, the angular velocity detection element 3 can be supported at both ends from both sides in the X-axis direction by the leads 41 to 46, and a posture of the angular velocity detection element 3 is stabilized.

Further, the leads 41 and 44 extend on the second axis J2 in a plan view from the Z-axis direction. The leads 42 and 43 are arranged in line symmetry relative to the second axis J2 with the lead 41 interposed between the leads 42 and 43. Similarly, the leads 45 and 46 are arranged in line symmetry relative to the second axis J2 with the lead 44 interposed between the leads 45 and 46. Therefore, the angular velocity detection element 3 can be supported at both ends from both sides in the Y-axis direction by the leads 41, 42, 43, 44, 45, and 46, and a posture of the angular velocity detection element 3 is further stabilized.

The leads 41, 42, 43, 44, 45, and 46 are formed to have the same width and the same length. Accordingly, resonance frequencies of the leads 41, 42, 43, 44, 45, and 46 can be matched with one another. When an n-th harmonic (n is an integer of 1 or more) of a drive frequency of the angular velocity detection element 3 coincides with the resonance frequency of one of the leads 41, 42, 43, 44, 45, and 46, the lead resonates in the drive vibration mode, and the resonance excites the detection vibration mode even though the angular velocity ωz is not applied. As a result, a zero point output fluctuates, and detection accuracy of the angular velocity ωz is lowered. When the resonance frequencies of the leads 41, 42, 43, 44, 45, and 46 are different, in terms of design, it is difficult to sufficiently shift all the resonance frequencies from the n-th harmonic of the drive frequency of the angular velocity detection element 3. On the other hand, it is easy to sufficiently shift all the resonance frequencies from the n-th harmonic of the drive frequency of the angular velocity detection element 3 by matching the resonance frequencies of the leads 41, 42, 43, 44, 45, and 46 with one another as in the embodiment. That is, in the embodiment, the resonance frequencies of the leads 41, 42, 43, 44, 45, and 46 are the same, and are different from a frequency of the n-th harmonic of the drive frequency of the angular velocity detection element 3.

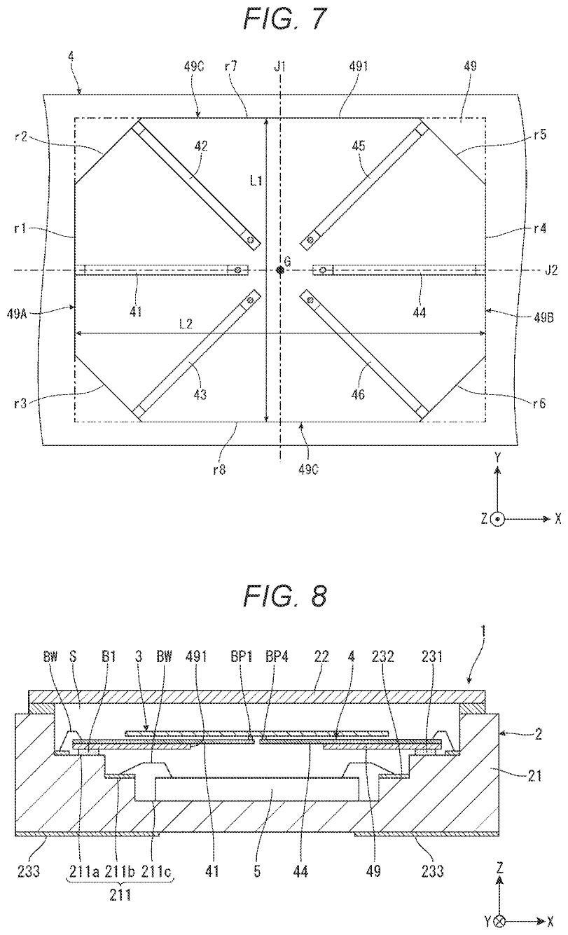

As shown in FIG. 7, the substrate 49 includes a first adjustment portion 49A and a second adjustment portion 49B that reduce a difference in length among the leads 41, 42, 43, 44, 45, and 46, and a third adjustment portion 49C that sets lengths of the leads 41, 42, 43, 44, 45, and 46 to be a predetermined length, as compared with a case where the opening 491 has a rectangular shape. In particular, the lengths of the leads 41, 42, 43, 44, 45, and 46 are made equal to one another by the first adjustment portion 49A and the second adjustment portion 49B in the embodiment.

The opening 491 has an octagonal shape with all corners being 135°. The opening 491 has a first side r1 located on a negative side in the X-axis direction of the first axis J1 and extending along the first axis J1, a fourth side r4 located on a positive side in the X-axis direction of the first axis J1 and extending along the first axis J1, a seventh side r7 located on a positive side in the Y-axis direction of the second axis J2 and extending along the second axis J2, an eighth side r8 located on a negative side in the Y-axis direction of the second axis J2 and extending along the second axis J2, a second side r2 located between the first side r1 and the seventh side r7, a third side r3 located between the first side r1 and the eighth side r8, a fifth side r5 located between the fourth side r4 and the seventh side r7, and a sixth side r6 located between the fourth side r4 and the eighth side r8.

The first adjustment portion 49A reduces a difference in length among the leads 41, 42, and 43 as compared with a case where the opening 491 has a rectangular shape. The first adjustment portion 49A includes the first side r1, and the second side r2 and the third side r3 that are coupled to both sides of the first side r1 among the eight sides of the opening 491. The lead 41 extends from the first side r1, the lead 42 extends from the second side r2, and the lead 43 extends from the third side r3. Since the second and third sides r2 and r3 are inclined toward the first axis J1 relative to the first side r1, the leads 42 and 43 are shorter than those in a case where the opening 491 has a rectangular shape indicated by a one-dot chain line. As a result, the difference in length among the leads 41, 42, and 43 is reduced. In the embodiment, the difference in length among the leads 41, 42, 43 is 0 (zero), that is, the leads 41, 42, 43 have the same length.

The second adjustment portion 49B is formed in line symmetry with the first adjustment portion 49A relative to the first axis J1. The second adjustment portion 49B reduces a difference in length among the leads 44, 45, and 46 as compared with a case where the opening 491 has a rectangular shape. The second adjustment portion 49B includes the fourth side r4, and the fifth side r5 and the sixth side r6 that are coupled to both sides of the fourth side r4 among the eight sides of the opening 491. The lead 44 extends from the fourth side r4, the lead 45 extends from the fifth side r5, and the lead 46 extends from the sixth side r6. Since the fifth and sixth sides r5 and r6 are inclined toward the first axis J1 relative to the fourth side r4, the leads 45 and 46 are shorter than those in a case where the opening 491 has a rectangular shape indicated by a one-dot chain line. As a result, the difference in length among the leads 44, 45, and 46 is reduced. In particular, in the embodiment, the difference in length among the leads 44, 45, and 46 is 0 (zero), that is, the leads 44, 45, and 46 have the same length. The lengths of the leads 41, 42, 43, 44, 45, and 46 do not necessarily have to be equal to one another, and each of the leads 41, 42, 43, 44, 45, and 46 may have a length at which each lead has a resonance frequency different from the frequency of the n-th harmonic of the drive frequency of the angular velocity detection element 3.

The lead 41 extends perpendicularly from the first side r1, the lead 42 extends perpendicularly from the second side r2, the lead 43 extends perpendicularly from the third side r3, the lead 44 extends perpendicularly from the fourth side r4, the lead 45 extends perpendicularly from the fifth side r5, and the lead 46 extends perpendicularly from the sixth side r6. In this manner, the leads 41, 42, 43, 44, 45, and 46 extends perpendicularly from the corresponding sides r1, r2, r3, r4, r5, and r6, so that the leads 41, 42, 43, 44, 45, and 46 are supported on the substrate 49 in a balanced manner. Therefore, a posture of the angular velocity detection element 3 is further stabilized.

With the first and second adjustment portions 49A and 49B, the lengths of the leads 41, 42, 43, 44, 45, and 46 can be matched with one another with a simple configuration. However, adjustment ranges of the lengths of the leads 41, 42, 43, 44, 45, and 46 are small. Therefore, the substrate 49 further includes the third adjustment portion 49C.

The third adjustment portion 49C is disposed between the first adjustment portion 49A and the second adjustment portion 49B, and sets a length L2 of the opening 491 in a direction along the second axis J2 to be larger than a length L1 of the opening 491 in a direction along the first axis J1. That is, L2>L1. The third adjustment portion 49C includes the seventh side r7 and the eighth side r8 among the eight sides of the opening 491. The seventh side r7 and the eighth side r8 are longer than the other sides r1, r2, r3, r4, r5, and r6. Accordingly, L2>L1. In this manner, by setting L2>L1, the leads 41, 42, 43, 44, 45, and 46 can be made longer while keeping the lengths of the leads 41, 42, 43, 44, 45, and 46 matched with one another, as compared with a case of L2≤L1. The lengths of the leads 41, 42, 43, 44, 45, and 46 can be adjusted by adjusting the length L2.

With the third adjustment portion 49C, the lengths of the leads 41, 42, 43, 44, 45, and 46 can be adjusted with a simple configuration such that resonance frequencies of the leads 41, 42, 43, 44, 45, and 46 are sufficiently separated from the n-th harmonic of the drive frequency of the angular velocity detection element 3.

### Circuit Element 5

The circuit element 5 is fixed to the bottom surface of the third recessed portion 211c via a fixing member such as a metal paste or an adhesive. The circuit element 5 is electrically coupled to the angular velocity detection element 3 via the support substrate 4. The circuit element 5 includes a drive circuit 51 that drives the angular velocity detection element 3 by applying a drive signal, and a detection circuit 52 that detects the angular velocity ωz based on first and second detection signals from the angular velocity detection element 3.

The angular velocity sensor 1 has been described above. As described above, the angular velocity sensor 1 includes the package 2, the support substrate 4 that is disposed in the package 2, that includes the substrate 49 having the opening 491, and that includes the leads 41, 42, 43, 44, 45, and 46 serving as the first lead, the second lead, the third lead, the fourth lead, the fifth lead, and the sixth lead, the first to sixth leads being supported by the substrate 49 and extending into the opening 491 in a plan view of the substrate 49, and the angular velocity detection element 3 that is disposed in a manner of overlapping the support substrate 4 in the package 2 and is coupled to the leads 41, 42, 43, 44, 45, and 46. When axes that pass through the center of gravity G of the angular velocity detection element 3 and are orthogonal to each other are defined as the first axis J1 and the second axis J2 in a plan view of the substrate 49, the substrate 49 includes the first adjustment portion 49A that is located on one side (a negative side in the X-axis direction) of the first axis J1, that is coupled to the leads 41, 42, and 43, and that reduces a difference in length among the leads 41, 42, and 43 as compared with a case where the opening 491 has a rectangular shape, the second adjustment portion 49B that is positioned on the other side (a positive side in the X-axis direction) of the first axis J1, that is coupled to the leads 44, 45, and 46, and that reduces a difference in length among the leads 44, 45, and 46 as compared with a case where the opening 491 has a rectangular shape, and the third adjustment portion 49C that is disposed between the first adjustment portion 49A and the second adjustment portion 49B, and that sets the length L2 of the opening 491 in a direction along the second axis J2 to be larger than the length L1 of the opening 491 in a direction along the first axis J1. According to such a configuration, the lengths of the leads 41 to 46 can be matched with one another by the first and second adjustment portions 49A and 49B, and the lengths of the leads 41 to 46 can be adjusted by the third adjustment portion 49C. Therefore, the leads 41 to 46 can be designed such that the resonance frequencies of the leads 41 to 46 are sufficiently separated from the n-th harmonic of the drive frequency of the angular velocity detection element 3. Accordingly, a fluctuation of a zero point output of the angular velocity detection element 3 is prevented, and the angular velocity sensor 1 capable of exhibiting excellent detection accuracy of the angular velocity ωz is obtained.

As described above, in a plan view of the substrate 49, the opening 491 has an octagonal shape, the first adjustment portion 49A includes the first side r1 located on one side of the first axis J1 and extending along the first axis J1, and the second side r2 and the third side r3 that are coupled to both sides of the first side r1 among the eight sides of the opening 491, and the second adjustment portion 49B includes the fourth side r4 located on the other side of the first axis J1 and extending along the first axis J1, and the fifth side r5 and the sixth side r6 that are coupled to both sides of the fourth side r4 among the eight sides of the opening 491. Accordingly, the configuration of the first and second adjustment portions 49A and 49B is simplified.

As described above, the third adjustment portion 49C includes the seventh side r7 that couples the second side r2 and the fifth side r5, and the eighth side r8 that couples the third side r3 and the sixth side r6 among the eight sides of the opening 491. Accordingly, the configuration of the third adjustment portion 49C is simplified.

As described above, the lead 41 extends perpendicularly from the first side r1, the lead 42 extends perpendicularly from the second side r2, the lead 43 extends perpendicularly from the third side r3, the lead 44 extends perpendicularly from the fourth side r4, the lead 45 extends perpendicularly from the fifth side r5, and the lead 46 extends perpendicularly from the sixth side r6. Accordingly, the leads 41, 42, 43, 44, 45, and 46 are supported on the substrate 49 in a balanced manner. Therefore, a posture of the angular velocity detection element 3 is further stabilized.

### Second Embodiment

FIG. 8 is a cross-sectional view showing an angular velocity sensor according to a second embodiment.

The angular velocity sensor 1 according to the embodiment is similar to that of the first embodiment described above except that the configuration of the support substrate 4 is different. In the following description, differences between the embodiment and the above-described embodiment will be mainly described, and description of the same matters will be omitted. In the drawings of the embodiment, the same reference numerals are given to configurations the same as those in the above-described embodiment.

Although only the leads 41 and 44 are shown in FIG. 8, the leads 41, 42, 43, 44, 45, and 46 are supported on an upper surface of the substrate 49, that is, a main surface close to the angular velocity detection element 3. Accordingly, as in the first embodiment described above, the angular velocity detection element 3 can be disposed above the support substrate 4 with a gap between the angular velocity detection element 3 and the support substrate 4 without inclining the leads 41, 42, 43, 44, 45, and 46 in the middle through the opening 491.

When the leads 41, 42, 43, 44, 45, and 46 are bent as in the first embodiment described above, the resonance frequencies of the leads 41, 42, 43, 44, 45, and 46 may be shifted from one another due to a shift of a bending position, a shift of a bending angle, or the like. In contrast, such a problem does not occur in the embodiment since it is not necessary to bend the leads 41, 42, 43, 44, 45, and 46, and the resonance frequencies of the leads 41, 42, 43, 44, 45, and 46 can be more reliably matched with one another.

In the embodiment, the leads 41, 42, 43, 44, 45, and 46 are electrically coupled to the internal terminals 231 by bonding wires BW.

As described above, the leads 41, 42, 43, 44, 45, and 46 are supported on the upper surface of the substrate 49, that is, the main surface close to the angular velocity detection element 3 in the embodiment. Accordingly, it is not necessary to bend the leads 41, 42, 43, 44, 45, and 46, and the resonance frequencies of the leads 41, 42, 43, 44, 45, and 46 can be more reliably matched with one another.

According to the second embodiment, the same effects as those of the first embodiment can be exhibited.

### Third Embodiment

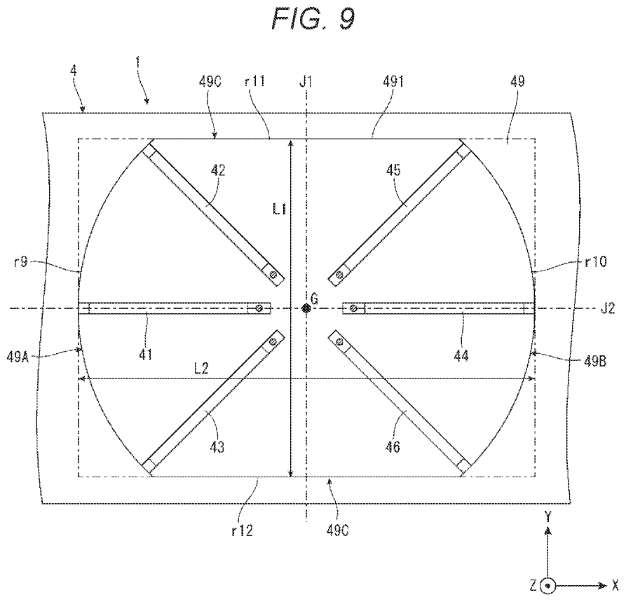

FIG. 9 is a top view showing a support substrate according to a third embodiment.

The angular velocity sensor 1 according to the embodiment is similar to that of the first embodiment described above except that a shape of the opening 491 is different. In the following description, differences between the embodiment and the above-described embodiment will be mainly described, and description of the same matters will be omitted. In the drawings of the embodiment, the same reference numerals are given to configurations the same as those in the above-described embodiment.

As shown in FIG. 9, the opening 491 according to the embodiment has a shape in which two opposite sides of a rectangle are arc-shaped. Specifically, the opening 491 has an arc-shaped side r9 located on a negative side in the x-axis direction of the first axis J1, an arc-shaped side r10 located on a positive side in the x-axis direction of the first axis J1, and a pair of sides r11 and r12 that couple the side r9 and the side r10 and extend along the second axis J2. In the substrate 49 having such a configuration, the leads 41, 42, and 43 extend from the side r9, and the leads 44, 45, and 46 extend from the side r10.

The first adjustment portion 49A includes the side r9. Since both end portions of the side r9 are inclined toward the first axis J1 relative to a central portion, the leads 42 and 43 are shorter than those in a case where the opening 491 has a rectangular shape indicated by a one-dot chain line. As a result, the difference in length among the leads 41, 42, and 43 is reduced. Similarly, the second adjustment portion 49B includes the side r10. Since both end portions of the side r10 are inclined toward the first axis J1 relative to a central portion, the leads 45 and 46 are shorter than those in a case where the opening 491 has a rectangle shape indicated by a one-dot chain line. As a result, the difference in length among the leads 44, 45, and 46 is reduced. The third adjustment portion 49C includes the sides r11 and r12. The lengths of the leads 41 to 46 can be adjusted while keeping the lengths matched with one another by adjusting the lengths of the sides r11 and r12.

According to the third embodiment, the same effects as those of the first embodiment can be exhibited.

### Fourth Embodiment

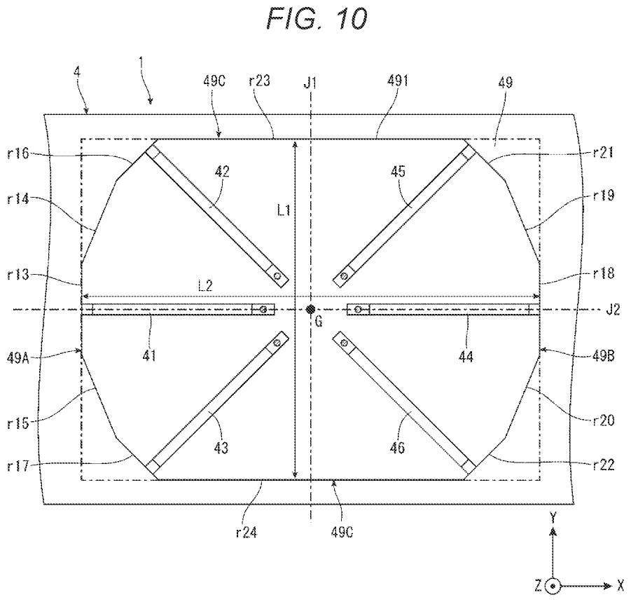

FIG. 10 is a top view showing a support substrate according to a fourth embodiment.

The angular velocity sensor 1 according to the embodiment is similar to that of the first embodiment described above except that a shape of the opening 491 is different. In the following description, differences between the embodiment and the above-described embodiment will be mainly described, and description of the same matters will be omitted. In the drawings of the embodiment, the same reference numerals are given to configurations the same as those in the above-described embodiment.

As shown in FIG. 10, the opening 491 according to the embodiment has a dodecagonal shape and has 12 sides r13 to r24. The lead 41 extends from the side r13, the lead 42 extends from the side r16, the lead 43 extends from the side r17, the lead 44 extends from the side r18, the lead 45 extends from the side r21, and the lead 46 extends from the side r22.

The first adjustment portion 49A includes the sides r13, r14, r15, r16, and r17. Since the sides r16 and r17 are inclined toward the first axis J1 relative to the side r13, the leads 42 and 43 are shorter than those in a case where the opening 491 has a rectangular shape indicated by a one-dot chain line. As a result, the difference in length among the leads 41, 42, and 43 is reduced. Similarly, the second adjustment portion 49B includes the sides r18, r19, r20, r21, and r22. Since the sides r21 and r22 are inclined toward the first axis J1 relative to the side r18, the leads 45 and 46 are shorter than those in a case where the opening 491 has a rectangular shape indicated by a one-dot chain line. As a result, the difference in length among the leads 44, 45, and 46 is reduced. The third adjustment portion 49C includes the sides r23 and r24. The lengths of the leads 41 to 46 can be adjusted while keeping the lengths matched with one another by adjusting the lengths of the sides r23 and r24.

According to the fourth embodiment, the same effects as those of the first embodiment can be exhibited.

Although the angular velocity sensor according to the disclosure has been described above based on the illustrated embodiments, the disclosure is not limited thereto. The configuration of each unit can be replaced with any configuration having the same function. In addition, any other component may be added to the disclosure.

What is claimed is:

1. An angular velocity sensor comprising:
a package;
a support substrate that is disposed in the package, that includes a substrate having an opening, and that includes a first lead, a second lead, a third lead, a fourth lead, a fifth lead, and a sixth lead supported by the substrate and extending into the opening in a plan view of the substrate; and
an angular velocity detection element that is disposed in a manner of overlapping the support substrate in the package, and is coupled to the first lead, the second lead, the third lead, the fourth lead, the fifth lead, and the sixth lead, wherein
when axes that pass through the center of gravity of the angular velocity detection element and are orthogonal to each other in the plan view are defined as a first axis and a second axis, the substrate includes
a first adjustment portion that is located on one side of the first axis, that is coupled to the first lead, the second lead, and the third lead, and that reduces a difference in length among the first lead, the second lead, and the third lead as compared with a case where the opening has a rectangular shape,
a second adjustment portion that is located on the other side of the first axis, that is coupled to the fourth lead, the fifth lead, and the sixth lead, and that reduces a difference in length among the fourth lead, the fifth lead, and the sixth lead as compared with a case where the opening has a rectangular shape, and
a third adjustment portion that is disposed between the first adjustment portion and the second adjustment portion and sets a length of the opening in a direction along the second axis to be larger than a length of the opening in a direction along the first axis.

2. The angular velocity sensor according to claim 1, wherein
the opening has an octagonal shape in the plan view,
the first adjustment portion includes a first side located on the one side of the first axis and extending along the first axis, and a second side and a third side that are coupled to both sides of the first side among eight sides of the opening, and
the second adjustment portion includes a fourth side located on the other side of the first axis and extending along the first axis, and a fifth side and a sixth side that are coupled to both sides of the fourth side among the eight sides of the opening.

3. The angular velocity sensor according to claim 2, wherein
the third adjustment portion includes a seventh side that couples the second side and the fifth side, and an eighth side that couples the third side and the sixth side among the eight sides of the opening.

4. The angular velocity sensor according to claim 2, wherein
the first lead extends perpendicularly from the first side,
the second lead extends perpendicularly from the second side,
the third lead extends perpendicularly from the third side,
the fourth lead extends vertically from the fourth side,
the fifth lead extends perpendicularly from the fifth side, and
the sixth lead extends perpendicularly from the sixth side.

5. The angular velocity sensor according to claim 1, wherein
the first lead, the second lead, the third lead, the fourth lead, the fifth lead, and the sixth lead are supported on a main surface of the substrate close to the angular velocity detection element.
